(19) United States
(12) Patent Application Publication
(10) Pub. No.: US 2006/0065133 A1
(43) Pub. Date: Mar. 30, 2006

(54) Fruit and vegetable juicer

(75) Inventor: Gary D. Moline, Upland, CA (US)

Correspondence Address: W. Norman Roth, Suite 707, 523 West 6th Street, Los Angeles, CA, 90014-1102, US

(73) Assignee: Moline Manufacturing Co., Inc.

(21) Appl. No.: 10/951,493

(22) Filed: Sep. 28, 2004

(51) Int. Cl. A23N 1/00

(52) U.S. Cl. 99/511

(57) ABSTRACT

An electrically powered juicer comprising a housing enclosing a feed chamber for reception of fruit or vegetables to be juiced, a juice chamber having a juice outlet, a rotary cutter, a rotary juice filter separating the feed chamber from the juice chamber and a perforated juice velocity reducer supported in the juice chamber at an elevation above the juice outlet to reduce turbulence and splashing, particularly at high speeds of rotation.

### CROSS REFERENCE TO RELATED APPLICATIONS, IF ANY

None

### BACKGROUND OF THE INVENTION AND PRIOR ART

The present invention relates generally to fruit and vegetable juicers of the type disclosed in my prior U.S. Pat. No. 6,050,180 issued Apr. 18, 2000, the full disclosure of which is incorporated herein by reference.

Electrically powered juicers of this general type have a filter basket and grating disc which rotate at speeds which are now as high as about 5200 RPM. This and higher speeds of rotation which are contemplated provide more rapid and efficient juicing but necessarily impart more turbulence to the juice and consequent splashing from the juice outlet or spout. The present invention is directed to this problem.

### OBJECT OF THE INVENTION

It is the primary objective of the invention to provide a juicer of the above type in which splashing due to turbulence is at least significantly reduced or eliminated.

### SUMMARY

Disclosed herein is an electrically powered juicer comprising a housing enclosing a feed chamber for reception of fruit or vegetables to be juiced. The housing defines a juice chamber having a juice outlet and containing a rotary cutter, a rotary juice filter separating the feed chamber from the juice chamber. A perforated juice velocity reducer is supported in the juice chamber at an elevation above the juice outlet.

### BRIEF DESCRIPTION OF THE DRAWINGS

FIG. 1 is a perspective view of a presently preferred embodiment of a juicer in accordance with the present invention;

FIG. 2 is an exploded perspective view of FIG. 1;

FIG. 3 is an elevational view of the cover;

FIG. 4 is a cross-sectional view of taken along line 4-4 in FIG. 1;

FIG. 4A is a portion of FIG. 4 to an enlarged scale;

FIG. 5 is a top plan view of the filter with the inserted cutter;

FIG. 6 is a sectional view of FIG. 5 along the line 6-6;

FIG. 7 is a perspective view of the underside of the cover, showing the helical design and shape which allows for more efficient pulp extraction;

FIG. 8 is a detailed sectional view of the relationship between the cover, collection bowl, and the filter; and.

FIG. 9 is a plan view of a velocity reducer plate.

### DESCRIPTION OF THE PREFERRED EMBODIMENT

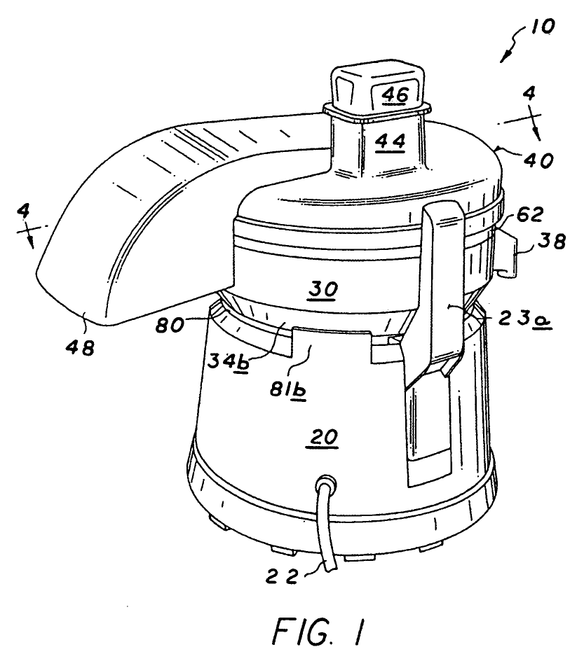

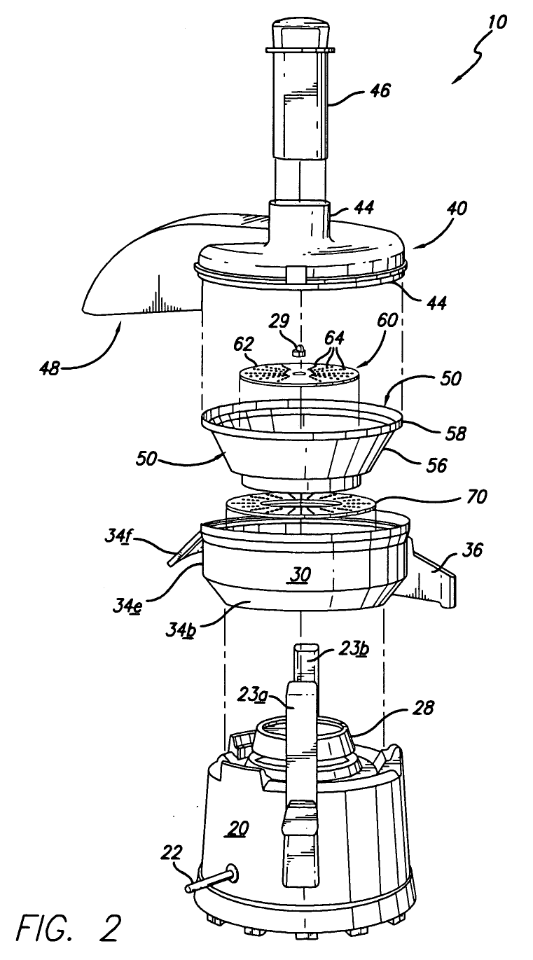

A typical embodiment of the present invention is illustrated in FIGS. 1 and 2. The fruit and vegetable juicer 10 comprises a base 20 having a power cord 22 leading to a motor 24 enclosed in the base 20. The motor 24 has a drive shaft 26 which upwardly extends through a rotary filter support 28 and an exposed end of non-circular, preferably hexagonal cross section which may be rotated at speeds up to 5200 RPM. A finger grip nut 29 is threaded onto the upper end of the drive shaft to secure a filter and cutter to be described below thereto.

The upper portion of the juicer 10 includes a collection bowl 30 supported on the base 20. The collection bowl forms an annular juice chamber 32 having spaced inner and outer diverging annular walls 34a and 34b which extend upwardly from a bottom wall 34c. A passageway 36 extends through the outer annular wall 34b to a juice discharge outlet depicted as a spout 38. The outer annular wall 34b has a lower upwardly and outwardly diverging portion 34d and a vertically extending upper portion 34e above the lower diverging portion 34d.

A cover 40 has a lower supporting edge 42 received in a supporting groove 39 formed at the upper edge of the collection bowl 30. The cover 40 also has a feed chute 44 leading into a feed chamber 45 for receiving fruit and/or vegetables to be juiced. A food pusher 46 is shown which is guided by the feed chute 44 and a pulp discharge chute 48 is formed in the cover 40. The base 20 is provided with at least one and preferably two latches 23a, 23b which may be affixed to the cover 40 for retaining the cover 40 and collection bowl 30 in position on the base 20.

A rotary filter 50 is positioned inside the collection bowl 30 and has a bottom wall 52 with a central non-circular, preferably hexagonal aperture 54 which receives the end of the drive shaft 26. The filter 50 has an upwardly and outwardly diverging finely perforated side wall 56 preferably of conical configuration which provides a sieve extending from the bottom wall 52 to a downwardly turned upper edge 58.

A cutter 60 in the form of a rotary plate having a central non-circular, preferably hexagonal aperture 62 which receives the complementary shaped end of the drive shaft 26 is positioned in the filter 50 adjacent the bottom wall 52. The cutter 60 has a plurality of juicing teeth 64 extending upwardly from its upper surface which may be arranged in radially extending lines as shown.

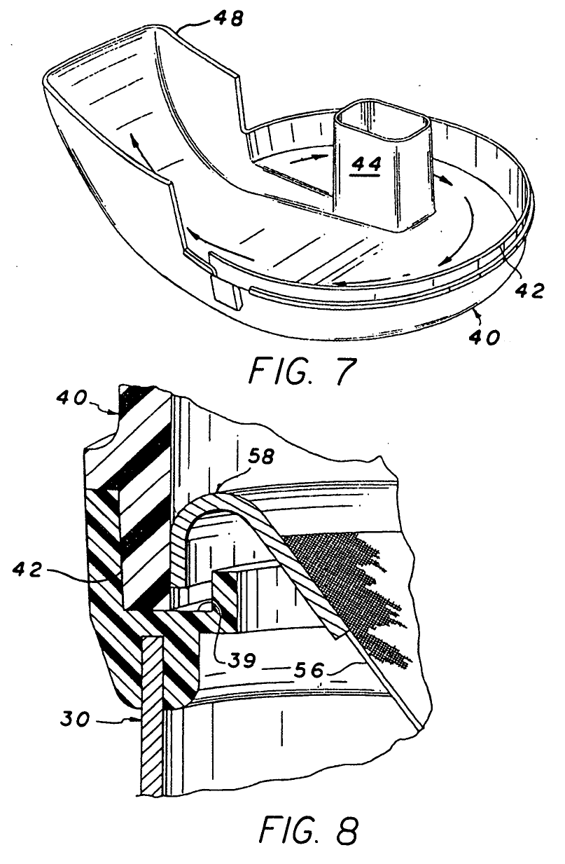

The cover 40 has a helical shape such that extracted pulp is centrifugally moved around the helical configuration to exit the cover 40 from the pulp discharge chute 48. A more detailed discussion of the helical shape is provided below with respect to FIG. 7.

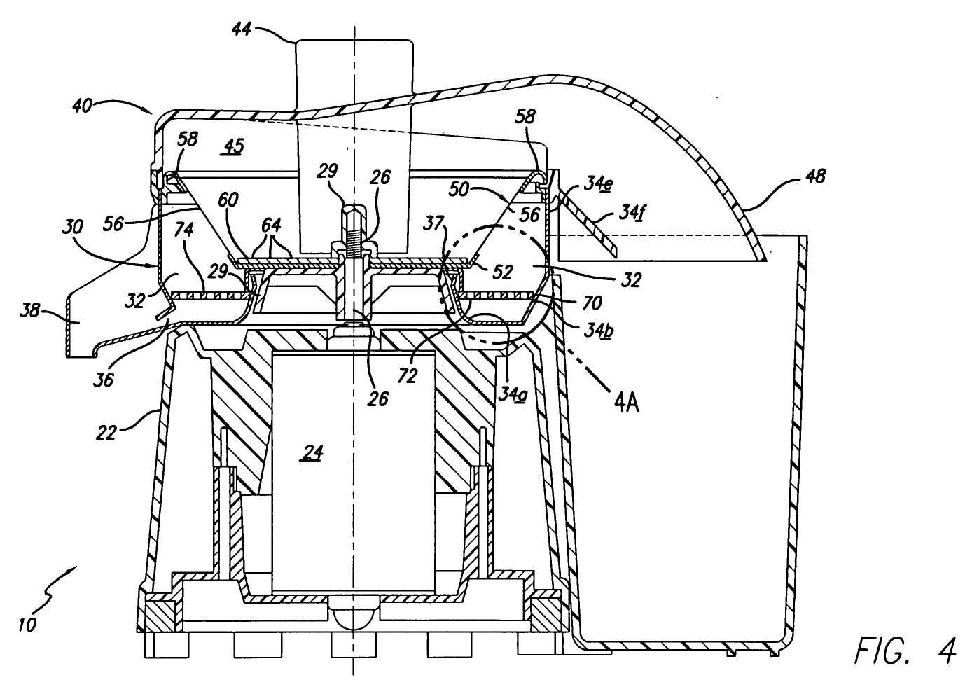

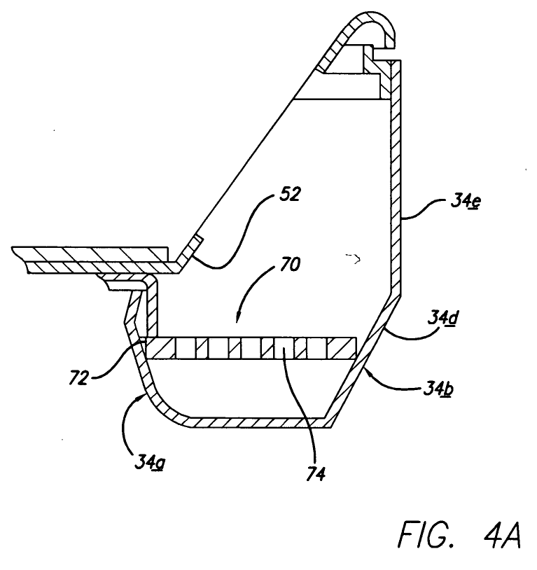

Referring to FIGS. 2 and 4, the base 20 has a collection bowl supporting surface with upwardly extending flanges configured to secure the collection bowl 30. The collection bowl 30 is stationary and positioned on the base 20. The collection bowl 30 has a central opening 34d in its bottom wall 34c surface whereby the bowl may fit annularly around the filter support 28.

A pulp-extraction flange 34f below the pulp discharge chute 48 extends from the annular vertical wall 34e of the collection bowl 30 for preventing dried pulp from dripping along the outer surface of the collection bowl 30.

The relationship between the cover 40, collection bowl 30 and filter 50 shown in FIG. 4 is illustrated in more detail in FIG. 8. The upper edge of the collection bowl 30 preferably is provided with an annular groove which engages and supports the lower edge of the cover 40, and also receives, on a radially inwardly extending ledge, the arcuately down-turned upper edge 58 of the filter 50. This enables the filter 50 to spin about its axis for extracting juice from fruits and vegetables. The down-turned upper edge 58 of the filter 50 provides clear flow of extracted pulp to the helical configuration shown in FIG. 7, in the cover 40 for expulsion of the extracted pulp. The above relationship facilitates separation of the juice from the pulp by preventing pulp from accumulating in the collection bowl 30.

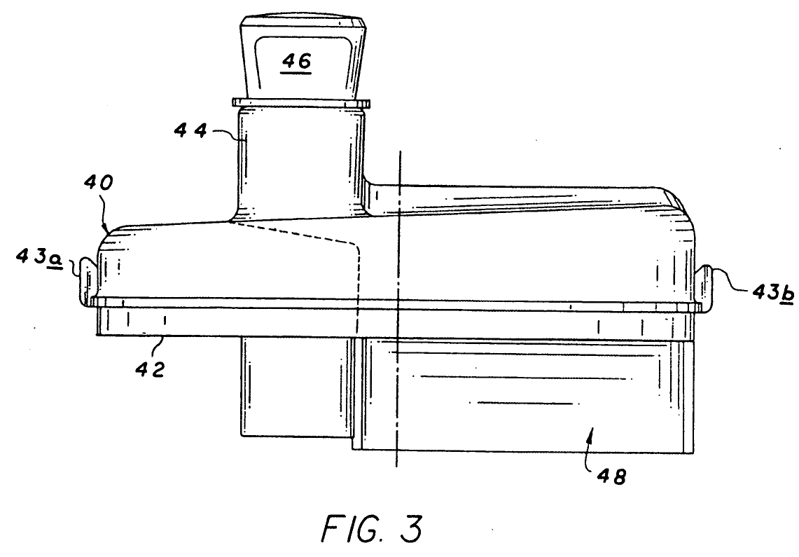

In FIG. 3 showing the cover 40, the location of the feed chute 44, with the food pusher 46 inserted is shown as being off-center from the central axis. The helical configuration of the interior of the cover 40 also shown in FIG. 7, begins at the lowest elevation of the underside of cover 40 and the elevation of that interior surface continually increases in a helical pattern until it reaches an apex. From the apex, the interior surface extends horizontally and then downward until it terminates at the pulp discharge chute 48.

FIG. 4 is a cross-section view of the juicer of FIG. 1, with the addition of a dried or reduced pulp receptacle. The motor 26 is located within the base 20 that in turn, includes the collection bowl support surface and flanges as illustrated in FIG. 2.

The cross-section view in FIG. 4, together with FIG. 7, illustrate the design of the helical recess in the cover 40. The helical configuration begins at the lowest elevation of the undersurface of the cover 40 and then increases in elevation, circumnavigating the feed chute 44 until the surface reaches its apex. At this point, the shape of cover 40 arcuately progresses from horizontal at the apex to near vertical at the distal end of the helical path. Following the helical flow path in the cover 40 the extracted pulp thus exits the at the pulp discharge chute 48 and may be gathered in a trash receptacle (unnumbered). The guide flange extending from the top edge of the collection bowl 30 aids in guiding the extracted pulp away from the outer surface of the collection bowl 30.

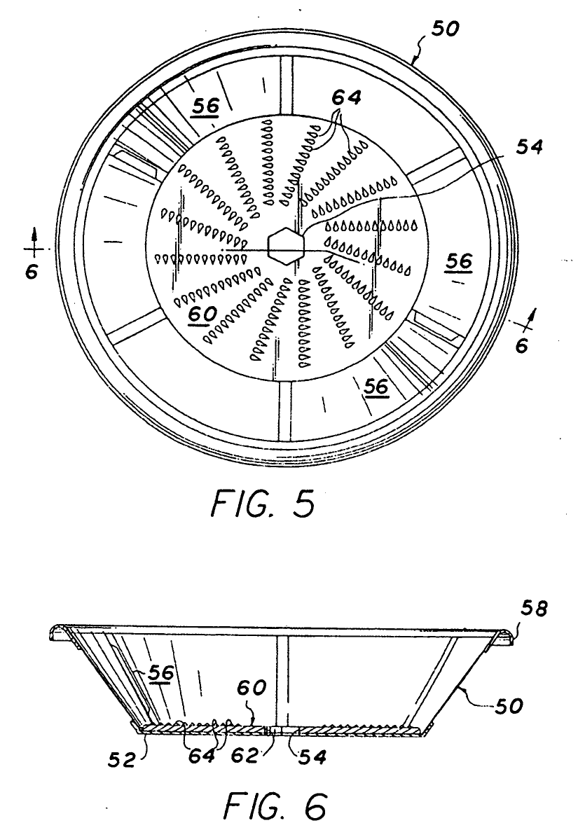

FIG. 5 illustrates a top view of the filter 50 with the cutter 60 placed therein. A plurality of radial rows of grating teeth 64 are formed around the top surface of the cutter 60. The central aperture 62 of the cutter 60 and the central aperture 54 of the filter 50, and, as noted previously, are preferably hexagonal in shape, but may be other configurations. These apertures match the exterior shape of the drive shaft 26 to provide a secure engagement between the structures.

FIG. 6 illustrates a cross-sectional view of the filter 50 and cutter 60, and further illustrates the shape of the downwardly turned upper edge 58 at the top of the filter 50.

FIG. 7 is a perspective view illustrating the helical shape of the underside surface of the cover 40. Arrows depict the flow path of extracted pulp.

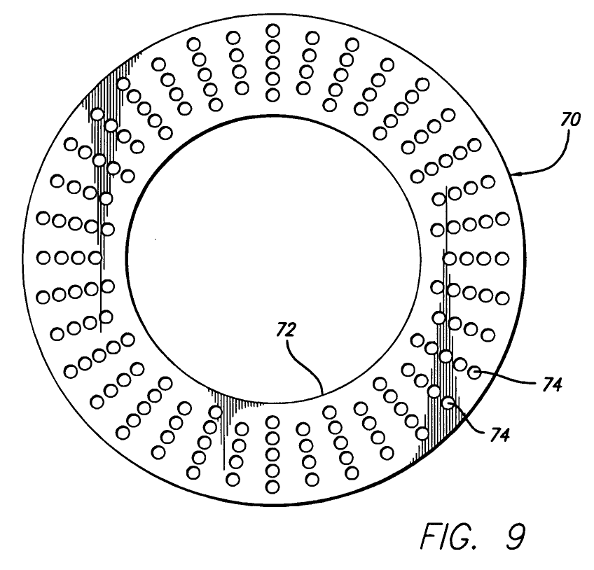

FIG. 8 is a plan view of the velocity reducer 70 which, in the presently preferred configuration, comprises a circular flat disc having a central aperture 72 sized to receive the filter support 28 and a plurality of juice turbulence reduction perforations 74 preferably extending vertically through the disc and preferably arranged along generally radially extending lines as shown. As shown, in FIGS. 4 and 9, the perforations 74 are of circular cross-section and extend perpendicular to the parallel upper and lower surfaces of the disc but such is not essential. For example, the perforations 74 may be of any other suitable cross-sectional configuration such as oval or elongated slots and the flow passageways formed by the perforations may be circumferentially angled in the direction of rotation of the filter 50 and cutter 60 or opposite thereto and/or they may be angled inwardly or outwardly in a radial direction. Also, the perforations 74 may vary in number and/or size along adjacent lines.

The velocity reducer 70 is supported at its lower outer edge on the wall of the juice chamber 32 which is angled with respect to the vertical as best seen in FIG. 4A. As shown, this comprises an outwardly and upwardly diverging, preferably frusto-conical, outer wall 34b of the collection bowl 30 contacted by the lower outer edge of the velocity reducer 70 at an elevation such that the lower surface of the velocity reducer 70 is just above the passageway 36 which extends from the collection bowl 30 to the juice spout 38. The velocity reducer 70 can be supported at this elevation in other ways as will be recognized by those skilled in the art.

Juice extracted through the perforated wall of the filter 50 flows generally circumferentially in the juice chamber 32 alongside the rotating filter 50 and downwardly to the velocity reducer 70 where it is forced to pass through the perforations 74 or through the central aperture 72 between the velocity reducer 70 and the filter support 29 to the underside of the velocity reducer 70 and thence to the passageway 36 which extends to the juice spout 38. Passage of the juice through the perforations 74 removes most, if not all, of the circumferential motion of the extracted juice before it is discharged at the spout 38 and thus minimizes splashing which otherwise occurs, particularly at increased speeds of rotation of the filter basket 50 and cutter 60. Some circumferential motion of the juice along the bottom wall 34c of the collection bowl 30 may be desired to eliminate any accumulation of extracted juice in areas of the collection bowl 30 remote from the passageway 36. For this purpose, the perforations 74 may be circumferentially angled with a component the direction of rotation of the filter 50 and cutter 60.

Persons skilled in the art will readily appreciate that various additional modifications can be made from the presently preferred embodiment thus the scope of protection is intended to be defined only by the appended claims.

1. An electrically powered juicer comprising a housing enclosing a feed chamber for reception of fruit or vegetables to be juiced, a juice chamber having a juice outlet, a rotary cutter, a rotary juice filter separating said feed chamber from said juice chamber and a perforated juice velocity reducer supported in said juice chamber at an elevation above said juice outlet.

2. The juicer of claim 1, wherein said velocity reducer comprises a disc supported by a wall of said juice chamber.

3. The juicer of claim 2, wherein said wall is angled with respect to the vertical.

4. The juicer of claim 3, wherein said disc is flat.

5. The juicer of claim 4, wherein said disc is circular and said wall is conical.

6. The juicer of claim 5, wherein said wall is an outer wall of said juice chamber.

7. The juicer of claim 6, wherein perforations in said disc are arranged on generally radially extending lines.

8. The juicer of claim 7, wherein said perforations are different in number along adjacent lines.

9. The juicer of claim 8, wherein said perforations are of equal diameter.

10. The juicer of claim 3, wherein said filter and said cutter are affixed to a motor driven drive shaft for rotation at speeds of approximately 5200 RPM.

11. The juicer of claim 1, wherein said housing includes a base having an electric motor therein with a vertically extending drive shaft, said housing including a lower section and a cover enclosing said feed chamber and said juice chamber.

12. The juicer of claim 11, wherein said drive shaft extends upwardly into said feed chamber from said base and said filter and said cutter are affixed to said drive shaft for rotation at speeds of approximately 5200 RPM.

13. The juicer of claim 12, wherein said juice chamber is in a collection bowl having spaced inner and outer diverging annular walls which extend upwardly from a bottom wall.

14. The juicer of claim 13, wherein said velocity reducer is supported on said outer annular wall and is spaced from said bottom wall.

15. The juicer of claim 14, wherein said juice outlet is spaced upwardly from said bottom wall.

16. The juicer of claim 15, wherein said outer annular wall has a lower outwardly diverging portion and a vertically extending upper portion above said lower diverging portion.

17. The juicer of claim 16, wherein said upper portion has an upwardly open groove receiving a lower edge of said cover.

18. An electrically powered juicer comprising a housing enclosing a feed chamber for reception of fruit or vegetables to be juiced, a juice chamber having a juice outlet, a rotary cutter, a rotary juice filter separating said feed chamber from said juice chamber and a perforated juice velocity reducer comprising a circular disc supported by a wall of said juice chamber in said juice chamber at an elevation above said juice outlet.

19. The juicer of claim 18, wherein said wall is an outer wall of said juice chamber.

20. The juicer of claim 19, wherein said disc is supported by a conical portion of said wall.
